(19) United States
(12) Patent Application Publication
(10) Pub. No.: US 2016/0083594 A1
(43) Pub. Date: Mar. 24, 2016

(54) A METHOD OF PREPARING A CONDUCTIVE METALLIC LAYER OR PATTERN

(71) Applicant: AGFA GEVAERT, Mortsel (BE)

(72) Inventors: Dirk BOLLEN, Mortsel (BE); Nicolas VRIAMONT, Mortsel (BE)

(21) Appl. No.: 14/891,047

(22) PCT Filed: Jul. 2, 2014
(86) PCT No.: PCT/EP2014/064015

§ 371 Date: Nov. 13, 2015

(30) Foreign Application Priority Data
Jul. 4, 2013 (EP) 13175030.9

(51) Int. Cl. C09D 5/24; B05D 3/10; B05D 3/00; B05D 1/42

(52) U.S. Cl. CPC C09D 5/24; B05D 1/42; B05D 3/107; B05D 3/007

(57) ABSTRACT

A method of preparing a conductive metallic layer or pattern includes the steps of applying a metallic nanoparticle dispersion on a support to obtain a metallic layer or pattern, and contacting the metallic layer or pattern with a solution containing an acid or an acid precursor capable of releasing the acid during curing of the metallic layer or pattern. It has been observed that by contacting the metallic layer or pattern with a solution containing an acid or an acid precursor capable of releasing the acid, higher conductivities at moderate curing conditions are obtained.

### CROSS-REFERENCE TO RELATED APPLICATIONS

This application is a 371 National Stage Application of PCT/EP2014/064015, filed Jul. 2, 2014. This application claims the benefit of European Application No. 13175030.9, filed Jul. 4, 2013, which is incorporated by reference herein in its entirety.

### BACKGROUND OF THE INVENTION

1. Field of the Invention

The present invention relates to methods of preparing highly conductive patterns or coatings at moderate curing conditions from metallic nanoparticle dispersions.

2. Description of the Related Art

The interest in printing or coating fluids containing metallic nanoparticles has increased during the last decades due to the unique properties of such metallic nanoparticles, when compared to the bulk properties of a given metal. For example, the melting point of metallic nanoparticles decreases with decreasing particle size, making them of interest for printed electronics, electrochemical, optical, magnetic and biological applications.

The production of stable and concentrated metallic printing or coating fluids, which can be printed for example by inkjet printing or screen printing, or coated at high speed, is of great interest as it enables the preparation of electronic devices at low costs.

Typically metallic nanoparticles are prepared by the polyol synthesis methodology as disclosed in Mat. Chem. Phys. 114, 549-555, by a derivative of the polyol synthesis methodology or by an in-situ reduction of metallic salts in the presence of various reducing agents. Such methods are disclosed in for example US2010143591, US2009142482, US20060264518 and US20080220155, EP2147733, EP2139007, EP803551, EP2012952, EP2030706, EP1683592, EP166617, EP2119747, EP2087490 and EP2010314, WO2008/151066, WO2006/076603, WO2009/152388 and WO2009/157393.

In such a polyol synthesis, so called capping agents are often used to stabilize the metallic precursor or metallic nanoparticles. Such capping agents usually contain functional groups such as thiol (—SH), carboxyl (—COOH), or amine (—NH) groups. U.S. Pat. No. 8,197,717 for example discloses a metallic ink comprising metallic nanoparticles made by the polyol synthesis wherein the nanoparticles are capped by a capping material such as polyvinylpyrrolidone (PVP).

After applying the metallic printing or coating fluids on a substrate, a sintering step, also referred to as curing step, at elevated temperatures is carried out to induce/enhance the conductivity of the applied patterns of layers. The organic components of the metallic printing or coating fluids, for example polymeric dispersants or capping agents, may reduce the sintering efficiency and thus the conductivity of the applied patterns of layers. For this reason, higher sintering temperatures and longer sintering times are often required to decompose the organic components.

Such high sintering temperatures are not compatible with common polymer foils, such as polyethylene terephthalate (PET) or polycarbonate, which have relatively low glass transition temperatures. There is thus an interest in lowering the sintering temperatures needed to obtain conductive layers or patterns.

EP-A 2468827 discloses polymeric dispersants, which have a 95 wt % decomposition at a temperature below 300° C. as measured by Thermal Gravimetric Analysis. By using metallic printing or coating fluids comprising such polymeric dispersants, the sintering temperature and time could be reduced. In EP-A 11194791.7 and EP-A 11194790.9 both filed on 21Dec. 2011 a so called sintering additive is used in combination with a polymeric dispersant of EP-A 2468827 to further lower the sintering temperature. The amount of sintering additives, i.e. specific carboxylic acids or sulphonic acids, is more than 2 wt %, based on the total weight of the dispersion.

EP-A 12170774.9, filed on 05Jun. 2012, discloses a metallic nanoparticle dispersion comprising a dispersion medium characterized in that the dispersion medium comprises a specific solvent, for example 2-pyrrolidone. When using such a solvent as dispersion medium, no polymeric dispersants are necessary to obtain stable metallic nanoparticle dispersions.

However, there still is a need of further reducing the curing time and temperature of metallic coatings and patterns. It may be advantageous, for example for stability reasons, to use a method wherein a compound which enhances the curing efficiency is not present in the metallic nanoparticle dispersion but is contacted with the metallic layers or patterns just before the curing step.

### SUMMARY OF THE INVENTION

Preferred embodiments of the present invention provide a method of preparing highly conductive coatings or patterns from metallic nanoparticle dispersions at moderate curing conditions.

The advantages and benefits realised by the methods are as defined below. These methods may be considered as alternative solutions to a particular problem, i.e. increasing the conductivity of metallic layers or patterns.

It has been found that contacting metallic layers or patterns with a solution containing an acid or acid precursor capable of releasing the acid during curing, results in a substantial increase of the conductivity of the metallic layers or patterns.

Further advantages and embodiments of the present invention will become apparent from the following description.

### DETAILED DESCRIPTION OF THE PREFERRED EMBODIMENTS

A method of preparing a conductive metallic layer or pattern according to a first embodiment of the present invention comprises the steps of:

applying a metallic nanoparticle dispersion on a support to obtain a metallic layer or pattern,

contacting the metallic layer or pattern with a solution containing an acid or an acid precursor capable of releasing the acid during curing of the metallic layer or pattern.

Preferably, a method further comprises a curing step after contacting the metallic layer or pattern with the solution containing the acid or the precursor.

The metallic layer or pattern may be contacted with a solution containing an acid or acid precursor by dipping the metallic layer or pattern in a solution containing the acid or the acid precursor or by coating a solution containing the acid or the precursor on the metallic layer or pattern.

The solution containing the acid or the acid precursor may be an aqueous solution or a non-aqueous solution, preferably an aqueous solution. The concentration of the solution may be between 0.1 and 50.0 wt %, preferably between 0.5 and 25 wt %, more preferably between 1.0 and 10.0 wt %.

Dipping the metallic layer or pattern in the solution containing the acid or the acid precursor may be carried out in a tank containing the solution. This can be done manually or the metallic layer may be conveyed through the solution by conveying means.

Dipping can be carried out at room temperature. The dipping time maybe varied to obtain optimal results as function of the concentration of the solution. It has been observed that very short dipping times, i.e. seconds, may already improve the curing efficiency and thus the conductivity.

In a preferred embodiment, the metallic layer of pattern is immersed in the solution containing the acid at higher temperatures, for example between 30 and 90° C., more preferably between 40 and 80° C. It has been observed that immersion at higher temperatures led to high conductivities of the metallic layer or pattern, without an additional curing or annealing step. The fact that no additional curing step is necessary is of course an advantage.

The acid used is preferably an inorganic acid. An inorganic acid, also referred to as mineral acid, is an acid derived from one or morge inorganic compounds. Preferably, the inorganic acid has a pKa lower than 4.5, more preferably lower than 3.

Inorganic acids that may be used are for example HCl, HBr, HI, HF, H₂SO₄, H₃PO₄, HPO₃, H₃PO₂, H₄P₂O₇, HNO₃, H₃BO₃, HClO₄, HClO₃S, H₂FO₃P, HPF₆, H₂SeO₃, H₃NO₃S, H₂SO₃, and HBF₄.

Preferred inorganic acids are the hydrohalides HX, wherein X is F, Br, CL or I, H₂SO₄, H₃PO₄, H₃PO₂ and HNO₃. Particularly preferred inorganic acid are HCl and HBr.

An acid precursor, capable of generating an acid during curing of a metallic layer or pattern formed from the dispersion may be used instead of or in addition to the acid mentioned above.

The precursors preferably generate hydrohalides HX, wherein X is F, Br, CL or I, more preferably HCl or HBr.

Some examples of acid precursors that may be used in the present invention are listed in Table 1.

TABLE 1

| | |
|---|---|
| AP-01 | 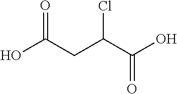 |
| AP-02 | 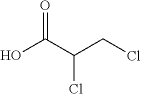 |
| AP-03 | 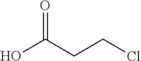 |
| AP-04 | 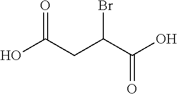 |
| AP-05 | 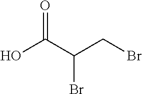 |
| AP-06 | 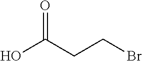 |
| AP-07 | 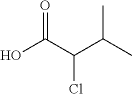 |
| AP-08 | 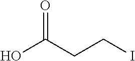 |
| AP-09 | 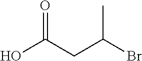 |

To have a sufficient influence on the curing efficiency, the inorganic acid has to be, at least partially, generated in the time and temperature window wherein the curing is carried out.

The curing time is preferably less than 60 minutes, more preferably less than 30 minutes, most preferably less than 15 minutes. The curing temperature is preferably less than 250° C., more preferably less than 200° C., most preferably less than 160° C.

The optimal concentration of the acid precursor may be adjusted as function of the curing time and temperature. For example, a higher concentration may be used when the curing time and temperature are rather low to ensure that enough acid is liberated during curing.

It may be advantageous to contact the metallic layer or pattern with the solution containing the acid or the acid precursor just before the curing step: preferably less than 1 hour, more preferably less than 30 minutes, most preferably less than 10 minutes.

The metallic layers or patterns may be dried before contacting them with the solution containing the acid or the acid precursor.

A method of preparing a conductive metallic layer or pattern according to a second embodiment of the present invention comprises the steps of:

providing a support having on at least one side of the support a primer layer,

applying a metallic nanoparticle dispersion on the primer layer to obtain a metallic layer or pattern,

curing the metallic layer or pattern,

characterized in that the primer comprises a compound capable of generating an acid during curing of the metallic layer or pattern.

The acid that is liberated is preferably HCl. A particularly preferred compound capable of generating HCl during curing is a copolymer of vinylidene chloride, an acrylic ester and itaconic acid.

The relative proportion of the monomers in the three-component copolymer is preferably 35 to 96 mol %, more preferably 60 to 94 mol % for vinylidene chloride; preferably 3.5 to 40, more preferably 5 to 35 for the acrylic ester; and preferably 0.5 to 25, more preferably 1 to 5 for itaconic acid.

Preferred acrylic esters that may be used to prepare the copolymer are alkyl esters of acrylic and methacrylic acids having from 1 to 18 carbon atoms in the alkyl group (e.g. methyl methacrylate, ethyl methacrylate, butyl methacrylate, octyl methacrylate, n-dodecyl methacrylate, n-ctadecyl methacrylate, methyl acrylate, ethyl acrylate and propyl acrylate).

The copolymer may be prepared by various copolymerization methods, for example the copolymerization method as disclosed in EP465726.

The copolymers can be coated on a support by any suitable technique. They may be applied as an organic solvent solution or from aqueous dispersion.

Other preferred primers containing a vinylidene chloride copolymer are those disclosed in EP343642.

The primer is provided at least on the side of the support whereupon the metallic layer of pattern will be provided.

An additional advantage of using a primer containing a compound capable of generating an acid during curing and in particular a primer comprising the vinylidene chloride copolymer disclosed above is a substantial improvement of the adhesion of the conductive metallic layer or pattern to the support.

Both methods may be combined. A metallic layer or pattern, applied on a primer layer containing a compound capable of generating an acid during curing, may be contacted with a solution containing an acid or acid precursor capable of releasing the acid during curing.

### Metallic Nanoparticle Dispersion

The metallic nanoparticle dispersion comprises metallic nanoparticles, a dispersion medium, and optionally one or more additives.

### Metallic Nanoparticles

The metallic nanoparticles comprise one or more metals in elemental or alloy form. The metal is preferably selected from the group consisting of silver, gold, copper, nickel, cobalt, molybdenum, palladium, platinum, tin, zinc, titanium, chromium, tantalum, tungsten, iron, rhodium, iridium, ruthenium, osmium, aluminium and lead. Metallic nanoparticles based on silver, copper, molybdenum, aluminium, gold, copper, or a combination thereof, are particularly preferred. Most preferred are silver nanoparticles.

The term “nanoparticles” refers to dispersed particles having an average particle size below 200 nm at the end of the dispersion preparation. The metallic nanoparticles have an average particle size at the end of the dispersion preparation of less than 200 nm, preferably less than 100 nm, more preferably less than 50 nm, most preferably less than 30 nm.

### Dispersion Medium

The disperion medium preferably comprises a solvent according to Formula I,

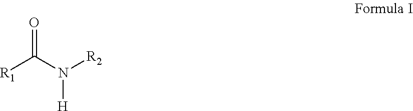

wherein
R₁ and R₂ represent an optionally substituted alkyl group, and
R₁ and R₂ may form a ring,

The term “alkyl” in Formula I means all variants possible for each number of carbon atoms in the alkyl group i.e. for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl etc.

In a preferred embodiment the dispersion medium comprises a solvent according to Formula II,

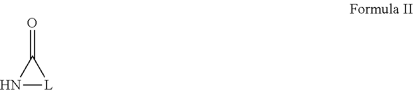

wherein
L is an optionally substituted linear or branched C₂-C₁₁ alkylene group.

In a more preferred embodiment the dispersion medium comprises a solvent selected from an optionally substituted 2-pyrrolidone, β-lactam, γ-lactam, δ-lactam, or ε-lactam.

In an even more preferred embodiment the metallic nanoparticle dispersion comprises as dispersion medium a solvent selected from 2-pyrrolidone, 4-hydroxy-2-pyrrolidone, δ-valerolactam or ε-caprolactam. In a most preferred embodiment the dispersion medium comprises 2-pyrrolidone.

The metallic nanoparticle dispersion comprises the solvent as defined above in an amount between 1 and 75 wt %, preferably between 2.5 and 50 wt %, more preferably between 5 and 25 wt % relative to the total weight of the dispersion.

The dispersion medium of the metallic nanoparticle dispersion may comprise, in addition to the solvent according to Formula I, a co-solvent, preferably an alcohol or a ketone. The co-solvent is more preferably ethanol or methylethyl ketone (MEK). The co-solvent may be present from the start of the preparation of the metallic nanoparticle dispersion or may be added during or at the end of the preparation.

### Polymeric Dispersant

The dispersion medium may contain a dispersant, typically a polymeric dispersant. However, as such polymeric dispersants (or other additives) may lower the conductivity of the coatings prepared with the metallic nanoparticle dispersion at low sintering temperatures, it is preferred not to use them.

Polymeric dispersants are typically homo- or copolymers prepared from acrylic acid, methacrylic acid, vinyl pyrrolidinone, vinyl butyral, vinyl acetate or vinyl alcohol monomers.

The polymeric dispersants disclosed in EP-A 2468827 having a 95 wt % decomposition at a temperature below 300° C. as measured by Thermal Gravimetric Analysis may also be used.

However, in a preferred embodiment the metallic nanoparticle dispersion according to the present invention comprises less than 5 wt % of a polymeric dispersant relative to the total weight of the dispersion, more preferably less than 1 wt %, most preferably less than 0.1 wt %. In a particularly preferred embodiment the dispersion comprises no polymeric dispersant at all.

### Printing or Coating Fluid

A metallic printing or coating fluid, also referred to respectively as a metallic ink or a metallic coating solution, may be prepared from the metallic nanoparticle dispersion.

The metallic nanoparticles dispersion may be directly used as a metallic printing or coating fluid. However, to optimize the coating or printing properties, and also depending on the application for which it is used, additives such as reducing agents, wetting/levelling agents, dewettting agents, rheology modifiers, adhesion agents, tackifiers, humectants, jetting agents, curing agents, biocides or antioxidants may be added to the metallic nanoparticle dispersion.

Preferably, the inorganic acid or the acid precursor generating such an acid may be added while preparing the metallic printing or coating fluid.

The total amount of additives is preferably less than 20 wt %, more preferably less than 10 wt %, and even more preferably less than 5 wt %, relative to the total weight of the metallic printing or coating fluid.

A thickening agent may be added to increase the viscosity of the printing or coating fluid. Preferred thickening agents may be selected from amorphous silica, polyvinylpyrrolidones having different Molecular Weights, and cellulose based thickening agents. A particular preferred thickening agent is hydroxypropylcellulose.

High boiling solvents are preferably added to the ink to prevent drying of the ink during printing. Moreover, such high boiling solvents may also have a positive influence on the conductivity of the ink. Preferred high boiling solvents are diethyleneglycol (DEG), 2-butoxyethanol and 1-methoxy-2-propanol.

Also diluents may be added to the metallic dispersions when preparing the metallic printing or coating fluids. The amount of these optional diluents is preferably less than 75 wt %, more preferably less than 60 wt % relative to the total weight of the ink. The diluents may be selected from alcohols, aromatic hydrocarbons, ketones, esters, aliphatic hydrocarbons, higher fatty acids, carbitols, cellosolves, and higher fatty acid esters. Suitable alcohols include methanol, ethanol, propanol, 1-butanol, 1-pentanol, 2-butanol, t-butanol. Suitable aromatic hydrocarbons include toluene, and xylene. Suitable ketones include methyl ethyl ketone, methyl isobutyl ketone, 2,4-pentanedione and hexa-fluoroacetone. Also glycol, glycolethers, N,N-dimethyl-acetamide, N,N-dimethylformamide may be used.

The preparation of the metallic printing or coating fluids comprises the addition of the optional additives and/or diluents to the metallic nanoparticle dispersion by using a homogenization technique such as stirring, high shear mixing, ultra-sonication, or a combination thereof. The homogenization step can be carried out at elevated temperature up to 100° C. In a preferred embodiment, the homogenization step is carried out at temperature equal or below 60° C.

In a preferred embodiment, a metallic screen printing ink is prepared. Such a screen printing ink has a viscosity between 3000 and 400000 mPa·s, preferably between 5000 and 100000 mPa·s, more preferably between 10000 and 50000 mPa·s. According to a particularly preferred embodiment, a silver screen printing ink is prepared.

In another preferred embodiment, a metallic flexographic or gravure ink is prepared. Such an ink has a viscosity between 50 and 3000 mPa·s, preferably between 200 and 1000 mPa·s, most preferably between 300 and 500 mPas·s. According to a particularly preferred embodiment, a silver flexographic ink is prepared.

In another preferred embodiment, a metallic inkjet ink is prepared. Such an inkjet ink has a viscosity between 1 and 50 mPa·s, preferably between 5 and 30 mPa·s, more preferably between 7 and 15 mPa·s. According to a particularly preferred embodiment, a silver inkjet ink is prepared.

The viscosities referred to above are measured at a shear rate of 1/s at temperature between 20 and 25° C. (for example with an AR2000 Rheometer from Texas Instruments).

### Metallic Layers or Patterns

The metallic layers or patters are prepared by a method comprising the steps of applying a printing or coating fluid as defined above on a support.

Multiple metallic layers or patterns, i.e. a stack of patterned or unpatterned layers, may be applied on a substrate. The support referred to in a method of preparing the metallic layers or patterns thus also encompass a previously applied metallic layer or pattern.

The metallic layers or patterns may also be realized by inkjet printing or by any conventional printing techniques such as flexography, offset, gravure or screen printing or by any conventional coating technique such as spray coating, blade coating, slot die coating.

After the layers or patterns are applied on the substrate, a sintering step, also referred to as curing step, may be carried out. During this sintering step, solvents evaporate and the metallic particles sinter together. Once a continuous percolating network is formed between the metallic particles, the layers or patterns become conductive. Conventional curing is carried out by applying heat. The curing temperature and time are dependent on the substrate used and on the composition of the metallic layer or pattern. The curing step for curing the metallic layers may be performed at a temperature below 250° C., preferably below 200° C., more preferably below 180° C., most preferably below 160° C.

The curing time is preferably ≦60 minutes, more preferably ≦30 minutes and most preferably ≦15 minutes, depending on the selected temperature, substrate and composition of the metallic layers.

However, instead of or in addition to the conventional curing by applying heat, alternative curing methods such as exposure to an Argon laser, to microwave radiation, to UV radiation or to low pressure Argon plasma, photonic curing, plasma or plasma enhanced, electron beam or pulse electric current sintering may be used.

The metallic layers of the present invention allow low enough curing temperatures making it is possible to use polymeric substrates that can not withstand thermal treatment at high temperature, such as for example PET. The low curing times enables a high productivity.

As has been described above, no curing step is necessary to obtain high conductivities when the metallic layers or patterns are immersed in the solution containing an acid at higher temperatures, for example between 30 and 90° C.

The conductivity of the metallic layers or patters, after curing and expressed as % of the bulk conductivity (of the metal) is preferably ≧10, more preferably ≧20%, most preferably ≧30%.

The metallic layers or patterns may be used in various electronic devices or parts of such electronic devices as for example organic photo-voltaics (OPV's), inorganic photo-voltaics (c-Si, a-Si, CdTe, CIGS), OLED displays, OLED lighting, inorganic lighting, RFID's, organic transistors, thin film batteries, touch-screens, e-paper, LCD's, plasma, sensors, membrane switches or electromagnetic shielding.

### Method to Prepare the Metallic Nanoparticle Dispersion

The metallic nanoparticle dispersion can be prepared by any known method to prepare such dispersions.

A preferred method to prepare a metallic nanoparticle dispersion comprises the steps of:

dispersing metal precursor particles in a dispersion medium comprising a solvent according to Formula I; and

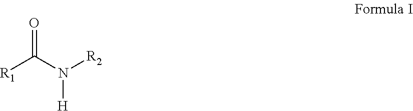

wherein
R₁ and R₂ represent an optionally substituted alkyl group, and
R₁ and R₂ may form a ring,

reducing the metal precursor with a reducing agent to form metallic nanoparticles.

The metal precursor dispersion is prepared by adding the metal precursor to the dispersion medium, containing the solvent according to Formula I.

The metal precursor particles are typically available as powders, flakes, particles or aggregated particles. Prior to the dispersion preparation the flakes or powders may be down-sized by mean of dry milling, wet-milling, high shear dispersion methods or sieving techniques.

To prepare the metal precursor dispersion typical dispersion methods such as precipitation, mixing, milling, in-situ synthesis or a combination thereof may used. The experimental conditions such as temperature, process time, energy input, etc. depend on the methodology chosen. The dispersion process can be carried out in a continuous, batch or semi-batch mode.

Mixing apparatuses may include a pressure kneader, an open kneader, a planetary mixer, a dissolver, a high shear stand mixer, and a Dalton Universal Mixer. Suitable milling and dispersion apparatuses are a ball mill, a pearl mill, a colloid mill, a high-speed disperser, double rollers, a bead mill, a paint conditioner, and triple rollers. Many different types of materials may be used as milling media, such as glasses, ceramics, metals, and plastics. The dispersions may also be prepared using ultrasonic energy.

The concentration of the metal precursor dispersion, expressed in wt % metal, is preferably between 1 and 50 wt %, more preferably between 2 and 25 wt %, most preferably between 3 and 15 wt %.

The metallic nanoparticles are prepared from metal precursor particles by means of a reduction step, for example the reduction of metal oxides to metals.

Metal precursor particles may be selected from the group consisting of metal oxides, metal salts, metal hydroxides, and metal complexes.

Preferred metal oxide particles are silver oxide, tin oxide, titanium oxide, zirconium oxide, wolfram oxide, molybdenum oxide, cadmium oxide, cupper oxide or zinc oxide particles.

Also doped metal oxide particles such as ZnO:Al, SnO₂:F or SnO₂:Sb particles may be used.

Preferred metal hydroxide particles are copper hydroxide, titanium hydroxide, zirconium hydroxide, wolfram hydroxide, molybdenum hydroxide, cadmium hydroxide or zinc hydroxide particles.

Preferred metal salts include inorganic acid salts, such as nitrates, carbonates, chlorides, phosphates, borates, sulfonates and sulfates, and organic acid salts, such as stearate, myristate or acetate.

As mentioned above, particularly preferred metallic nanoparticles are silver nanoparticles. These may be prepared, for example, by the reduction of silver oxide, silver nitrate or silver acetate.

The reducing agents used in this reduction step are preferably soluble in the dispersion medium. The reducing agents may be selected from the group consisting of hydroxylamine and derivatives thereof, formic acid, oxalic acid, ascorbic acid, hydrazine and derivatives thereof, dithiothreitol, phosphites, hydrophosphites, phosphorous acid and derivatives thereof, lithium aluminum hydride, diisobutylaluminum hydride, sodium borohydride, sulfites, tin(II) complexes, iron(II) complexes, zinc mercury amalgam, sodium amalgam, atomic hydrogen, or Lindlar catalyst.

Preferred reducing agents are hydroxylamine of derivatives thereof, N,N-diethylhydroxylamine being particularly preferred. Another preferred reducing agent is formic acid.

The amount of reducing agent used, expressed as molar ratio of the reducing agent to metal is preferably between 0.6 and 10, more preferably between 0.8 and 8, most preferably between 1 and 6.

The degree of reduction of the metal precursor to metallic nanoparticles is preferably between 60 and 100%.

The reducing agent is preferably added to the dispersion in a controlled way, so as to prevent a too fast reduction of the precursor.

Another preferred method to prepare a metallic nanoparticle dispersion according to the present invention comprises the steps of:

forming a metal precursor dispersion or solution by adding a metallic precursor to a dispersion medium comprising;

(a) a solvent according to Formula I, and

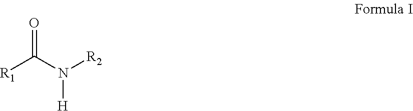

wherein
R₁ and R₂ represent an optionally substituted alkyl group,
R₁ and R₂ may form a ring,

(b) a carboxylic acid according to Formula III,

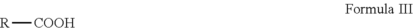

wherein
R is an optionally substituted C2-C7 alkyl, alkenyl, alkynyl or cycloalkyl group,

reducing the metallic precursor with a reducing agent to form metallic nanoparticles;

sedimenting the metallic nanoparticles to obtain a concentrated metallic nanoparticle dispersion comprising at least 15 wt % of metallic nanoparticles.

It has been observed that by using the combination of the solvent according to Formula I and the carboxylic acid according to Formula III, a fine and homogenous sediment of metal nanoparticles can be obtained, which is easily redispersed and with which highly conductive layers may be prepared. A possible explanation may be that both the solvent according to Formula I and the carboxylic acid according to Formula III stabilize the metal precursor particles and/or the metal nanoparticle which may result in the absence of agglomerates of particles. There are indications that the solvent according to Formula I especially stabilizes the metal nanoparticles, while the carboxylic acid stabilizes the metal precursor particles.

The reaction or dispersion medium used in a preferred method to prepare the metallic nanoparticle dispersion contains a carboxylic acid according to Formula III,

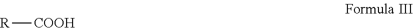

wherein
R is an optionally substituted C₂-C₇ alkyl, alkenyl, alkynyl or cycloalkyl group.
   A C₂-C₇ alkyl, alkenyl, alkynyl or cycloalkyl group contains between 2 and 7 carbon atoms.

R is preferably an optionally substituted C2-C7 alkyl group. The term “alkyl” means all variants possible for each number of carbon atoms in the alkyl group i.e. for three carbon atoms:

n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl etc.

Preferably R is a n-alkyl group. When the chain length of the alkyl group increases an increase of the viscosity of the reaction mixture has been observed. On the other hand, the acids with a shorter alkyl group have an unacceptable smell. The R group in Formula III is most preferably a C4-C6 n-alkyl group.

Particularly preferred carboxylic acids according to Formula III are pentanoic acid, hexanoic acid and heptanoic acid.

The amount of carboxylic acid according to Formula III used in a method of the present invention, expressed as molar ratio of carboxylic acid to metal is preferably between 1 and 10, more preferably between 2 and 8, most preferably between 3 and 6.

The metal precursor dispersion is prepared by adding the metal precursor to the dispersion medium as described for the dispersion method disclosed above. The dispersion medium however now contains the solvent according to Formula I and the carboxylic acid according to Formula III.

The metallic nanoparticles are prepared from metal precursor particles by means of a reduction step, for example the reduction of metal oxides to metals. The reduction may be carried out as disclosed above.

To realize a highly concentrated metallic nanoparticle dispersion comprising at least 15 wt % of metallic nanoparticles, a sedimentation step is carried out after the reduction step.

After the sedimentation step, a fine, homogeneous sediment of metallic nanoparticles is obtained. The sedimentation step, and the optional washing steps, also results in the removal of organic ingredients (solvent, carboxylic acid, reducing agent, binder) that may have a negative influence on the conductivity of coatings from the dispersions.

Preferably, after the reduction step the dispersion is transferred to a sedimentation vessel containing a stirrer and a tube to remove the supernatant. However, other methods to separate the sediment from the supernatant may also be used.

Sedimentation is preferably carried out by allowing the mixture to stand without stirring for some time, for example overnight.

Sedimentation may however be induced or accelerated by solvent evaporation, by adding a non-solvent, by centrifugation or by ultracentrifugation.

When sedimentation is complete, the supernatant is removed from the sediment. It is very important no to disturb the sediment during the separation of the supernatant from the sediment.

Preferably, one or more washing steps are carried out on the sediment obtained, to further remove, at least partially, unwanted ingredients still present in the sediment.

In a washing step, a solvent is added to the sediment and the resulting dispersion is stirred for some time, for example one hour or half an hour.

Then, the mixture is allowed to stand without stirring for some time, for example one hour, resulting in a sediment and a supernatant. The supernatant is then removed.

Several washing steps may be carried out, using the same or different solvents.

The solvents are chosen taking into account the removal of unwanted ingredients from the sediment and the sedimentation of the metal nanoparticles in that solvent. Reversible agglomeration of the metal nanoparticles may accelerate the sedimentation. It has been observed that metal nanoparticles prepared by a method of the present invention, i.e. in the presence of the solvent of Formula I and the carboxylic acid according to Formula III, are indeed characterized by such a reversible aggregation, thus accelerating the sedimentation but forming easily redispersible sediment.

The solvent used in the last washing step is chosen, also taking the conductivity and the print properties of the printing or coating fluid made from the dispersion into account.

In a preferred embodiment, four washing steps are carried out. The first two washing steps with 1-methoxy-2-propanol, the last two with Butylcellosolve™, a butylglycolether from DOW CHEMICALS.

The highly concentrated metallic nanoparticle dispersion obtained by a method of the present invention contains at least 15 wt %, more preferably at least 30 wt %, most preferably at least 50 wt % of metallic nanoparticles, relative to the total weight of the dispersion. Particularly preferred, the metallic nanoparticle dispersion contains between 60 and 80 wt % of metallic nanoparticles relative to the total weight of the dispersion.

### EXAMPLES

### Materials

All materials used in the following examples were readily available from standard sources such as ALDRICH CHEMICAL Co. (Belgium) and ACROS (Belgium) unless otherwise specified. All materials were used without further purification unless otherwise specified.
Butylcellosolve™ is a butylglycolether from DOW CHEMICALS.
Dowanol PM™ is 1-methoxy-2-propanol from DOW CHEMICALS.
Klucel™ J, is hydroxypropylcellulose from HERCULES.
DAPRO DF 6800, a defoaming agent (polysiloxane containing hydrophobically modified silica) from ELEMENTIS.
Disperbyk®-2025, a wetting additive from BYK Additives & Instruments.
IPA is isopropyl alcohol.
EtOAc is ethylacetate.
AcOH is acetic acid.
THF is tetrahydrofuran.
MEK is methylethylketon.
DMA is N,N-dimethylacetamide.
NMP is N-methyl pyrrolidone.
Silver oxide from UMICORE.
Copol (ViCl₂-MA-IA), a copolymer of vinylidenechloride-methacrylic acid and itaconic acid from Agfa Gevaert.
Mersolat H40, a surfactant from Lanxess.
Kieselsol 100F, a silica from Bayer.

### Example 1

### Preparation of the Silver Nanoparticle Dispersion NPD-01

576.0 g of 2-pyrrolidone, 576.0 g of ethanol and 1728.0 g of YTZ pearls were added to a 2 litre PE vessel. To this mixture, 320.0 g silver oxide (from Umicore) was added. The closed vessel was then placed on a “roller mill” for 24 hours. After removing the YTZ pearls a pre-dispersion is obtained.

44.26 ml of formic acid was added to the pre-dispersion (1.25 ml/min) at 22° C. The mixture was then stirred over night at 22° C. The mixture was then filtered using a 60 μm filter cloth. The filtrate was then concentrated at 40° C., first for 60 min at 110 mbar, then for 30 min at 60 mbar.

The obtained silver nanoparticle dispersion NPD-01 had ±20 wt % of silver, relative to the total weight of the dispersion.

### Example 2

The silver nanoparticle dispersion NPD-01 and a dispersion obtained by first diluting the dispersion with a 50/50 wt % mixture of 2-fenoxyethanol/2-methylpyrrolidone were then coated on polyester (blade coater, coating thickness was 10 μm) to obtain the coated layers CL-01 and CL-02.

CL-01 and CL-02 were then subjected to several treatments: drying, applying an overcoat of a 1% HCl solution on the coated layers, and curing in the order shown in Table 2.

The surface resistance (SER) of the coated layers after subjecting them to the different treatments was measured using a four-point collinear probe. The surface or sheet resistance was calculated by the following formula:

SER=(n/ln 2)*(V/I)

wherein
SER is the surface resistance of the layer expressed in Ω/;
π is a mathematical constant, approximately equal to 3.14; ln 2 is a mathematical constant equal to the natural logarithmic of value 2, approximately equal to 0.693;
V is voltage measured by voltmeter of the four-point probe measurement device;
I is the source current measured by the four-point probe measurement device.

For each sample, three measurements were performed at different positions of the coating and the average value was calculated.

The silver content M_{Ag} (g/m²) of the coatings was determined by WD-XRF.

The conductivity of the coated layers was determined by calculating the conductivity as a percentage of the bulk conductivity of silver using the following formula:

$$\% {Ag}_{( bulk )} = \frac{{ρ}_{Ag} * {σ}_{Ag}}{{M}_{Ag} * SER} * {10}^{- 5} * 100 \% = \frac{0.1663}{{M}_{Ag} * SER} * 100 \%$$

wherein
ρ_{Ag} is the density of silver (10.49 g·cm⁻³) and σ_{Ag} the specific conductivity of silver (equal to 6.3 10⁵S/cm).

The conductivities of the coated metallic layers are shown in Table 2.

TABLE 2

| | | Drying | HCl | Curing | % Ag |
|---|---|---|---|---|---|
| | | 75° C.-10 min | overcoat | 150° C.-30 min | bulk |
| INV-01 | CL-01 | Yes | Yes | — | 16.8 |
| INV-02 | CL-01 | Yes | Yes | Yes | 25.0 |
| INV-03 | CL-02 | Yes | Yes | Yes | 29.4 |
| COMP-01 | CL-01 | Yes | No | Yes | 10.1 |
| COMP-02 | CL-02 | Yes | No | Yes | 9.6 |
| COMP-03 | CL-01 | No | No | Yes | 11.2 |
| COMP-04 | CL-02 | No | No | Yes | 7.5 |
| INV-04 | CL-01 | No | Yes | Yes | 28.8 |
| INV-05 | CL-02 | No | Yes | Yes | 21.4 |

It is clear from the results in Table 2 that the inventive examples wherein an overcoat of HCl has been applied have the highest conductivity.

### Example 3

### Preparation of the Silver Nanoparticle Dispersion NPD-02

78.0 g of silver oxide was slowly added, while stirring, to a 1 l reactor containing 275.0 g of pentanoic acid and 401.0 g of

2-pyrrolidone. The temperature of the mixture was kept at 25° C.

After complete addition of the silver oxide, the suspension was stirred overnight at 25° C.

Then, 300.0 g of N,N-diethylhydroxylamine was added in a time span of 1.5 hours to the suspension. The temperature of the reaction mixture was kept at 25° C. When all reducing agent was added, the reaction mixture was kept at 25° C. while stirring for another hour.

The reaction mixture is then fed to a sedimentation vessel, where it was kept overnight, without stirring. The supernatant was carefully removed from the sediment.

The obtained sediment was washed four times, two times with Dowanol PM™ (547 g) and two times with Butylcellosolve™ (547 g). In each washing step, the solvent was added to the sediment and the resulting suspension stirred for 0.5 hour at 300 rpm. Then, the unstirred suspension was kept for another hour, and the supernatant carefully removed.

After the last washing step with Butylcellosolve™, the sediment was centrifuged, in a centrifugal decanter from Rousselet Robatel (France) at 3000 rpm during 0.5 hour.

The obtained silver nanoparticle dispersion NPD-02 had ±41 wt % of silver, relative to the total weight of the dispersion.

### Example 4

The silver nanoparticle dispersions NPD-01 and NPD-02 were coated on polyester (blade coater, coating thickness was 10 μm) and dried at 120° C. during 3 minutes to obtain the coating layers CL-03 and CL-04. Then, a HCl overcoat (HCl OC) was applied on the silver layer (wet coating thickness was 20 μm) and dried at the conditions shown in Table 3. Two different HCl overcoats were used: OC-01 was coated from a 5 wt % HCL solution in butylcellosolve, OC-02 was coated from a 5 wt % HCl solution in Ethanol.

The conductivities were measured as in Example 2 and shown in Table 3.

TABLE 3

| | CL | HCl OC | Drying | % Ag bulk |
|---|---|---|---|---|
| COMP-05 | CL-03 | — | 150° C./10 min | 0 |
| COMP-06 | CL-04 | — | 150° C./10 min | 6.4 |
| INV-06 | CL-03 | OC-01 | 150° C./10 min | 39.9 |
| INV-07 | CL-04 | OC-01 | 150° C./10 min | 73.8 |
| INV-08 | CL-03 | OC-02 | 25° C./10 min | 40.2 |
| INV-09 | CL-04 | OC-02 | 25° C./10 min | 66.2 |
| INV-10 | CL-03 | OC-02 | 150° C./10 min | 41.8 |
| INV-11 | CL-04 | OC-02 | 150° C./10 min | 89.3 |

It is clear from Table 3 that the conductivity increases when a HCl overcoat was applied on the silver layer. In the presence of a HCl overcoat, high conductivities were obtained when the curing was carried out at room temperature.

### Example 5

A coating solution was prepared by adding Klucel J (12.6 wt %), butylcellosolve (1.4 wt %) to the silver nanoparticle dispersion NPD-02 (86 wt %). The coating solution was then coated on a polyester substrate with or without a primer provided one side of the support (blade coater, coating thickness was 10 μm) and dried at 120° C. during 3 minutes. The primer was coated from an aqueous coating solution. The composition of the primer is shown in Table 4.

TABLE 4

| Ingredients | (mg/m²) |
|---|---|
| Copol (ViCl₂-MA-IA) | 151.00 |
| Kieselsol 100F | 35.00 |
| Mersolat H40 | 0.75 |

Curing was carried out as shown in Table 5. The conductivities were measured as in Example 2 and shown in Table 5.

TABLE 5

| | primer | curing | % Ag bulk |
|---|---|---|---|
| COMP-07 | No | 150° C./30 min | 1.7 |
| INV-12 | Yes | 150° C./30 min | 10.5 |
| COMP-08 | No | 130° C./30 min | 1.4 |
| INV-13 | Yes | 130° C./30 min | 5.3 |

It is clear from table 5 that higher conductivities are observed when the metallic layers are provided on the primer of Table 4.

### Example 6

From the silver nanoparticle dispersion NPD-01 a paste was prepared by evaporation of the dispersion solvent. The paste had a silver content of ±47 wt %, relative to the total weight of the dispersion.

The paste was then coated on a polyester substrate with or without a primer provided one side of the support (blade coater, coating thickness was 10 μm) and dried at 120° C. during 3 minutes.

The primer of Example 5 is used.

Curing was carried out at 150° C. for 20 minutes. The conductivities were measured as in Example 2 and shown in Table 6.

TABLE 6

| | primer | curing | % Ag bulk |
|---|---|---|---|
| COMP-09 | No | 150° C./20 min | 0 |
| INV-14 | Yes | 150° C./20 min | 21.0 |

It is clear from table 6 that higher conductivities are observed when the metallic layers are provided on the primer of Table 4.

### Example 7

In this example, the method disclosed in WO2003/038002 has been carried out. In this method a silver layer is contacted with a solution containing a so-called flocculating agent, i.e. polydiallyldimethylammoniumchloride (PDAC).

The silver nanoparticle dispersion NPD-01 was diluted with a 50/50 wt % mixture of 2-fenoxyethanol/2-methylpyrrolidone and then coated on polyester (blade coater, coating thickness was 10 μm) to obtain the coated layer CL-05.

Then, a PDAC overcoat (PDAC OC) was applied on the silver layer (wet coating thickness was 40 μm). Two different PDAC overcoats were used: OC-03 was coated from a 1 wt % PDAC solution in water, OC-02 was coated from a 5 wt % PDAC solution in water.

After applying the overcoats, the coated layers were washed as shown in Table 7. Then curing was carried out at 120° C. during 30 minutes.

The conductivities shown in Table 7 were measured as in Example 2.

TABLE 7

| | PDAC OC | washing | % Ag bulk |
|---|---|---|---|
| COMP-10 | — | — | 0.1 |
| COMP-11 | — | water | 0.5 |
| COMP-12 | OC-03 | — | 0 |
| COMP-13 | OC-03 | ethanol | 0 |
| COMP-14 | OC-03 | water | 0.1 |
| COMP-15 | OC-03 | ethanol/water | 0.4 |
| COMP-16 | OC-04 | — | 0.5 |
| COMP-17 | OC-04 | ethanol | 0.2 |
| COMP-18 | OC-04 | water | 3.4 |
| COMP-19 | OC-04 | ethanol/water | 3.4 |

It is clear from Table 7 that contacting a silver layer with PDAC before curing, does not increase the conductivity of the cured silver layers as has been observed when for example a HCl overcoat has been applied on a silver layer (see Example 2).

### Example 8

The adhesion of the cured silver layers of Example 6 was evaluated by a cross hatch test (in accordance with ASTM D3359, scale 0 B to 5 B wherein the adhesion increases from 0 B to 5 B.

The results are shown in Table 8.

TABLE 8

| | primer | Adhesion | % Ag bulk |
|---|---|---|---|
| COMP-09 | No | OB | 0 |
| INV-14 | Yes | 5B | 21.0 |

It is clear from table 8 that the presence of the primer not only increases the conductivity of the silver layer but also the adhesion of the silver layer to the support.

### Example 9

The silver nanoparticle dispersion NPD-02 prepared in example 2 was screen printed on a pMMA substrate having a thickness of approximately 4 mm (Polyester P180 sieve, Ulano CDF Matrix UV film, flood bar angle=70°, squeegee angle=50°, full coverage).

The conductivity of the printed silver, after being subjected to different treatments in the order as shown in Table 9, was then evaluated.

TABLE 9

| | | Immersion | | | % Ag |
|---|---|---|---|---|---|
| | Drying 1 | treatment | Drying 2 | Curing | bulk |
| COMP-20 | air dried * | — | — | — | 0 |
| COMP-21 | air dried * | water | air dried * | — | 0 |
| | | 1 min/25° C. | 10 min | | |
| COMP-22 | air dried * | water | air dried * | — | 0 |
| | | 1 min/25° C. | 20 min | | |
| COMP-23 | air dried * | water | air dried * | — | 0 |
| | | 1 min/25° C. | 30 min | | |
| COMP-24 | air dried * | — | — | — | 0 |
| COMP-25 | air dried * | — | — | — | 0 |
| INV-15 | air dried * | 1% HCl | air dried * | — | 13.9 |
| | | 1 min/25° C. | 10 min | | |
| INV-16 | air dried * | 1% HCl | air dried * | — | 14.1 |
| | | 1 min/25° C. | 20 min | | |
| INV-17 | air dried * | 1% HCl | air dried * | — | 14.3 |
| | | 1 min/25° C. | 30 min | | |
| INV-18 | 30 min/70° C. | 1% HCl | air dried * | — | 11.1 |
| | | 5 min/25° C. | 10 min | | |
| INV-19 | 30 min/70° C. | 1% HCl | air dried * | — | 11.2 |
| | | 5 min/25° C. | 20 min | | |
| INV-20 | 30 min/70° C. | 1% HCl | air dried * | — | 11.3 |
| | | 5 min/25° C. | 30 min | | |
| INV-21 | air dried * | 1% HCl | air dried * | 15 min | 26.5 |
| | | 1 min/25° C. | 10 min | 150° C. | |
| INV-22 | 30 min/70° C. | 1% HCl | air dried * | — | 20.9 |
| | | 1 min/70° C. | 10 min | | |
| INV-23 | 30 min/70° C. | 1% HCl | air dried * | — | 20.9 |
| | | 1 min/70° C. | 20 min | | |
| INV-24 | 30 min/70° C. | 1% HCl | air dried * | — | 20.6 |
| | | 1 min/70° C. | 30 min | | |

* at room temperature

It is clear that immersion of the silver prints in a HCl solution (all inventive examples) resulted in an increase of the conductivity of the printed silver.

The highest conductivities are observed with INV-21 wherein after immersion in a HCl solution and drying, an additional curing step (15 min/150° C.) is carried out. INV-22 to INV-24 however show that by immersing the silver print in a HCl solution at higher temperatures (70° C.) high conductivities are obtained without such an additional curing step.

1-15. (canceled)

16. A method of preparing a conductive metallic layer or pattern, the method comprising the steps of:
applying a metallic nanoparticle dispersion on a support to form the conductive metallic layer or pattern; and
contacting the conductive metallic layer or pattern with a solution including an acid or an acid precursor that releases the acid during curing of the conductive metallic layer or pattern.

17. The method according to claim 16, wherein the step of contacting the conductive metallic layer or pattern with the solution includes coating the solution on the conductive metallic layer or pattern.

18. The method according to claim 16, wherein the step of contacting the conductive metallic layer or pattern with the solution includes dipping the conductive metallic layer or pattern in the solution.

19. The method according to claim 18, wherein the solution contains the acid, and the solution is at a temperature between 30° C. and 90° C. when the conductive metallic layer or pattern is dipped in the solution.

20. The method according to claim 16, further comprising the step of curing the conductive metallic layer or pattern.

21. A method of preparing a conductive metallic layer or pattern, the method comprising the steps of:
providing a support including a primer layer on at least one side of the support; and
applying a metallic nanoparticle dispersion on the primer layer to form the conductive metallic layer or pattern; wherein
the primer layer includes an acid or a compound that releases the acid during curing of the conductive metallic layer or pattern.

22. The method according to claim 16, wherein the acid is an inorganic acid.

23. The method according to claim 22, wherein the inorganic acid is selected from the group consisting of HCl, HBr, HI, HF, H₂SO₄, HNO₃, H₃PO₂, and H₃PO₄.

24. The method according to claim 23, wherein the inorganic acid is HCl or HBr.

25. The method according to claim 21, wherein the acid is an inorganic acid.

26. The method according to claim 25, wherein the inorganic acid is selected from the group consisting of HCl, HBr, HI, HF, H₂SO₄, HNO₃, H₃PO₂, and H₃PO₄.

27. The method according to claim 26, wherein the inorganic acid is HCl or HBr.

28. The method according to claim 21, wherein the primer layer includes a vinylidene chloride copolymer.

29. The method according to claim 16, wherein the metallic nanoparticle dispersion includes silver nanoparticles.

30. The method according to claim 21, wherein the metallic nanoparticle dispersion includes silver nanoparticles.

31. The method according to claim 16, wherein the metallic nanoparticle dispersion includes one or more additives selected from a thickening agent, a high boiling solvent, and a wetting agent.

32. The method according to claim 21, wherein the thickening agent is a cellulose derivative.

33. The method according to claim 21, wherein the high boiling solvent is selected from diethylene-glycol, 1-methoxy-2-propanol, and 2-butoxyethanol.

34. The method according to claim 20, wherein the step of curing the conductive metallic layer or pattern is performed at a temperature of 150° C. or less and within 30 minutes or less.
